(19) United States
(12) Patent Application Publication
(10) Pub. No.: US 2009/0042502 A1
(43) Pub. Date: Feb. 12, 2009

(54) Vehicle Air Purifier with a Negative and Positive Ion Generator and Air Conditioning System Using the Same

(75) Inventors: Jae-Ho Kim, Daejeon (KR); Young-Jun Jee, Daejeon (KR)

Correspondence Address: PATENT LAW GROUP LLP, 2635 NORTH FIRST STREET, SUITE 223, SAN JOSE, CA, 95134, US

(73) Assignee: HALLA CLIMATE CONTROL CORP., Deajeon (KR)

(21) Appl. No.: 12/159,182

(22) PCT Filed: Dec. 29, 2006
(86) PCT No.: PCT/KR06/05910

§ 371 Date: Jun. 25, 2008

(30) Foreign Application Priority Data
Dec. 30, 2005 (KR) 10-2005-0135132
Dec. 30, 2005 (KR) 10-2005-0135134

(51) Int. Cl. B60H 3/06; H01T 23/00; B03C 3/017

(52) U.S. Cl. 454/139; 361/231; 96/80

(57) ABSTRACT

The present invention relates to a vehicle air purifier with a negative/positive ion generator and an air conditioning system using the same. The vehicle air purifier includes a case including an air inlet and an air outlet, a filter arranged in the case at the side of the air inlet, a blower fan rotatably mounted in the case, and a negative/positive ion generator arranged in an air path of at least one of the air inlet and the air outlet, to emit negative ions and positive ions to air in accordance with emission of electrons. The negative/positive ion generator includes a body fixed to the case and provided with a high-voltage generator for generating high-voltage pulses, and a first discharge electrode and a second discharge electrode electrically connected to the high-voltage generator, to generate electrons by the high-voltage pulses applied from the high-voltage generator, and to emit the electrons to the air path of the at least one of the air inlet and air outlet, thereby causing negative ions and positive ions to be generated.

### TECHNICAL FIELD

The present invention relates to a vehicle air purifier with a negative/positive ion generator and an air conditioning system using the same, and more particularly to a vehicle air purifier which includes a negative/positive ion generator capable of uniformly supplying a large amount of negative and positive ions to the overall portion of the interior of the vehicle without generation of secondary pollutants harmful to the human body and discharge noise, to remove odor and various harmful substances contained in air present in the interior of the vehicle, and providing sterilization effects to maintain the interior of the vehicle in a pleasant state.

### BACKGROUND ART

Recently, the demand that the interior of a vehicle be maintained in a pleasant state has increased due to an increase in the number of vehicle owned and increased air pollution.

Generally, during running of a vehicle, bacterial particulate such as dust or mote produced on the road, pollen, and various harmful substances present in polluted air, such as sulfur dioxide gas (SO₂), nitrogen compounds (NOₓ), or carbon monoxide (CO), are introduced into the interior of the vehicle. In particular, when a heater or an air conditioner installed in the vehicle operates in a cold or damp weather, odor and bacterial particulate produced during the operation of the heater or air conditioner are directly introduced into the interior of the vehicle, called a cabin. As a result, the driver or other occupants in the cabin of the vehicle become uncomfortable.

To this end, an air filter is mounted to an air conditioner for a vehicle, in order to prevent bacterial particulate or harmful substances from being introduced into the cabin of the vehicle, and thus to supply purified air to the driver and occupants.

FIG. 1 is a schematic view illustrating an inner structure of a general air conditioner for a vehicle.

As shown in FIG. 1, the general vehicle air conditioner includes a blower unit 104 for selectively sucking internal air present in the cabin of the vehicle or external air into an air conditioner case 100 through an internal air inlet 101 or an external air inlet 102 in accordance with selective opening or closing of an internal/external air switching door 103. The air conditioner also includes an evaporator 106 for cooling air blown from the blower unit 104 in accordance with driving of an electric motor 105, a heater core 107 arranged adjacent to the evaporator 106, and adapted to heat air, and a temperature control door 108 arranged between the evaporator 106 and the heater core 107, and adapted to control the temperature of air discharged into the cabin of the vehicle in accordance with an opening/closing angle of the temperature control door 108. The air conditioner further includes a plurality of vents 109, 110, and 111 respectively connected to different regions of the cabin, to allow air cooled or heated in accordance with selective opening/closing of the temperature control door 108 to be discharged into the regions, and a plurality of mode doors 112, 113, and 114 for selectively changing the flow direction of the air discharged through respective vents 109, 110, and 111.

In a vehicle air conditioner having the above-mentioned configuration, air sucked into the air conditioner case 100 in accordance with driving of the electric motor 105 of the blower unit 104 is guided to pass around the evaporator 106, through which a refrigerant flows, or around a heater core 107, through which a coolant for a vehicle engine flows, by the temperature control door 108, in order to exchange heat with the refrigerant or coolant. The resultant cold or hot air is distributed into the cabin in various directions through the vents 109, 110, and 111. Thus, cooling or heating of the cabin is achieved.

In this vehicle air conditioner, an air filter 115 is installed at the side of the internal air inlet 101, at the upstream side of the blower unit 104, or between the blower unit 104 and the evaporator 106, in order to purify air introduced into the cabin.

The air filter 115 may be a dust removal filter for removing bacterial particulate such as dust, an odor removal filter for removing odor components, or a combined filter that is a combination of the dust removal filter and odor removal filter. The odor removal filter or combined filter is configured to physically adsorb harmful substances present in the air, for example, using grains of activated coal, thereby filtering the air for odor elimination or deodorization in an external air introduction mode or an internal air circulation mode.

After a certain use term of the above-mentioned filter the amount of odor components, etc. adsorbed by and collected in micro pores of the activated coal reaches a saturated level, thereby causing the adsorption ability of the filter to be gradually reduced. As a result, odor components adsorbed in a high-temperature state are partially re-introduced into the cabin, so that the occupants in the cabin become uncomfortable. In particular, when the vehicle runs in the rainy season in summer in a state in which the cabin is shut from the external of the vehicle, the filter exhibits limited adsorption ability due to hot air introduced into the filter from the external of the vehicle. Furthermore, the odor components adsorbed on the surface of the filter may easily detach from the filter surface. As a result, odor may be directly introduced into the cabin during operation of the air conditioner, so that the air cleanness of the cabin may be greatly degraded.

Moreover, when the air in the cabin becomes poisonous, such a filter cannot provide an appropriate function because it only performs a simple filtering function, irrespective of the cabin air purification condition desired by the driver or occupants.

To this end, the driver or occupants frequently open the windows of the vehicle to ventilate the cabin. Otherwise, a separate air purifier is installed at an appropriate position in the cabin, for example on an instrument panel mounted to the front side of the cabin or a rack arranged in the rear of the rear seat in the cabin, in order to purify the air present in the cabin.

Meanwhile, recent use of an air purifier, which is capable of emitting negative ions beneficial to the human body in terms of health, in a cabin has increased.

FIG. 2 illustrates an example of such an air purifier.

As shown in FIG. 2, the air purifier includes a case 200 provided with an air inlet 201 and an air outlet 202, an air filter 203 arranged in the case 200 at the side of the air inlet 201, and a blower fan (not shown) mounted in the case 200. The air purifier also includes a negative ion generator arranged in the case 200. The negative ion generator generates negative ions to purify air flowing from the air inlet 201 toward the air outlet 202 via the air filter 203.

As shown in FIGS. 3 and 4, the negative ion generator includes a needle-shaped discharge electrode 210 functioning as a negative (−) pole and a ground electrode 211 functioning as a positive (+) pole. When a high DC voltage is applied between the discharge electrode 210 and the ground electrode 220, corona discharge occurs between the two poles, so that a large amount of electrons are emitted into air. The electrons emitted in a large amount in such a manner negatively ionize oxygen and moisture present in the air while striking the oxygen and moisture. Thus, purification of the air is achieved.

However, since the discharge occurring between the two poles in the above-mentioned negative ion generator in accordance with the application of the high voltage is silent discharge, ozone (O₃) exhibiting a high oxidation ability and harmful to the human body is also generated during the generation of negative ions.

The basic reaction formula of the ozone generation caused by the silent discharge is as follows:

O₂+e⁻→O+O+e⁻

O+O→O₂

O+O₂+M→O₃+M

O₂+O₂→O₃+O

That is, oxygen produces ozone in accordance with electron discharge. The produced ozone reacts with contaminants, so that it is reduced to oxygen. When such ozone is used as an oxidizer, it can remove bacteria and viruses without leaving harmful residues because it exhibits a very high sterilizing power. Also, ozone has a strong bleaching ability. In addition, ozone has an advantage in that it reacts with organic substances, such as smoke, other bad-smelling gas, and various harmful substances, and renders those organic substances harmless. However, ozone may exhibit harmful effects to the human body.

Such ozone exhibits severe affects on, mainly, children, the elderly, and patients with heart trouble. Ozone is dangerous gas, as can be seen from the results of recent research reporting that an increase in death toll by 7% occurs when the concentration of ozone increases by 0.1 ppm. To this end, many countries stipulate the allowable concentration of ozone, in order to strictly restrict generation of ozone.

The above-mentioned conventional negative ion generator has a problem in that ozone is inevitably produced as a by-product during generation of negative ions, due to the silent discharge. In particular, although it may be possible to reduce production of ozone, using a low voltage, there is another problem in that the amount of negative ions generated in this case is also reduced, so that it is impossible to obtain sufficient air purification effects.

Meanwhile, Japanese Patent Unexamined Publication No. 2005-71715 discloses an air conditioner including a negative/positive ion generator for generating positive ions in addition to negative ions, to purify air, taking into consideration the fact that it is impossible to effectively remove bacteria floating in the air, only using negative ions.

FIG. 5 is a sectional view schematically illustrating an air conditioner including the above-mentioned conventional negative/positive ion generator.

As shown in FIG. 5, the conventional negative/positive ion generator 306 includes a planar dielectric 302 arranged downstream from a blower fan 301 installed in the interior of the air conditioner 300, and a ground electrode 303 and a voltage application electrode 304 which face each other at opposite sides of the dielectric 302. The negative/positive ion generator 306 also includes a voltage application means 305 for applying a voltage to the ground electrode 303 and voltage application electrode 304.

In accordance with the above-mentioned technique, air is purified using the negative/positive ion generator. That is, when voltages of positive and negative polarities are alternately applied to the voltage application electrode 304 by the voltage application means 305, the dielectric 302 performs a polarization action. As a result, plasma discharge occurs in a layer of air contacting the ground electrode 303. Thus, a plasma zone is formed in the vicinity of the ground electrode 303. In the plasma zone, water molecules or oxygen molecules in the air are ionized or dissociated, thereby generating negative ions (O₂⁻) and positive ions (H₃O⁺). The generated negative and positive ions, which are blown into a certain space, enclose various bacteria, harmful substances, odor, etc. floating in air present in the space in the form of clusters, to render them harmless. Thus, the air is purified.

However, the above-mentioned conventional negative/positive ion generator has a problem of discharge noise because it uses a plasma discharge system in which plasma is directly discharged into the air, using a ceramic chip as a dielectric. There is another problem in that, although the conventional negative/positive ion generator exhibits high air purification efficiency in a narrow area, it exhibits low air purification efficiency in a wide area.

In particular, the plasma discharge causes problems in that the amount of generated ions is insufficient, secondary pollutants, such as ozone (O₃) and nitrogen oxides (NOₓ), harmful to the human body are produced in accordance with reaction of the generated ions with activated oxygen (O⁺) (for example, O₂⁻+O⁺→O₃).

### DISCLOSURE OF INVENTION

### Technical Problem

Therefore, the present invention has been made in view of the above problems, and it is an object of the present invention to uniformly emit a large amount of negative and positive ions to the overall portion of a cabin of the vehicle without generation of secondary pollutants harmful to the human body and discharge noise, thereby removing odor and various harmful substances contained in air present in the interior of the vehicle and to provide sterilization effects, thereby maintaining the cabin of the vehicle in a pleasant state.

Another object of the present invention is to provide a configuration capable of reliably supplying negative and positive ions to areas requiring sterilization and deodorization, to efficiently sterilize and deodorize a wide area, and thus to maximize air purification efficiency in a wide area.

### Technical Solution

In accordance with an aspect, the present invention provides an air purifier for a vehicle comprising: a case including an air inlet and an air outlet; a filter arranged in the case at the side of the air inlet; a blower fan rotatably mounted in the case; and a negative/positive ion generator arranged in an air path of at least one of the air inlet and the air outlet, to emit negative ions and positive ions to air in accordance with emission of electrons, wherein the negative/positive ion generator comprises: a body fixed to the case, the body including a high-voltage generator for generating high-voltage pulses; and a first discharge electrode and a second discharge electrode electrically connected to the high-voltage generator, the first and second discharge electrodes generating electrons by the high-voltage pulses applied from the high-voltage generator, and emitting the electrons to the air path of the at least one of the air inlet and the air outlet, thereby causing negative ions and positive ions to be generated.

In accordance with another aspect, the present invention provides an air conditioning system for a vehicle comprising a system case defined with an air path, a blower unit for blowing air to the air path, an air filter for filtering the blown air, an evaporator for cooling the blown air, and a heater core for heating the blown air, further comprising a negative/positive ion generator comprising: a body fixed to the system case, the body including a high-voltage generator for generating high-voltage pulses; and a first discharge electrode and a second discharge electrode electrically connected to the high-voltage generator, the first and second discharge electrodes generating electrons by the high-voltage pulses applied from the high-voltage generator, and emitting the electrons to the air path of the system case, thereby causing negative ions and positive ions to be generated.

### ADVANTAGEOUS EFFECTS

In accordance with the vehicle air purifier with the negative/positive ion generator according to the present invention and the air conditioning system using the same, it is possible to uniformly supply, to the cabin of the vehicle, a large amount of negative and positive ions incurring no production of secondary pollutants harmful to the human body, without discharge noise, because the negative ion generator for generating negative ions and the positive ion generator for generating positive ions are installed in an air path defined in the air purifier or in an air path defined in the system case. Accordingly, a pleasant cabin environment is maintained.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating an inner structure of a general air conditioner for a vehicle;

FIG. 2 is a perspective view illustrating an example of a conventional air purifier for generating negative ions;

FIGS. 3 and 4 are schematic views illustrating the principle of generation of negative ions in the conventional air purifier;

FIG. 5 is a sectional view schematically illustrating an air conditioner using another conventional negative/positive ion generator;

FIG. 6 is a perspective view illustrating a state in which a negative/positive ion generator is installed at the side of an air inlet in accordance with a first embodiment of the present invention;

FIGS. 7 and 8 are perspective views illustrating a configuration of the negative/positive ion generator according to the present invention;

FIGS. 9 and 10 are graphs depicting a variation in sterilizing power against bacterium samples depending on the spacing between first and second discharge electrodes included in the negative/positive ion generator according to the present invention, in which FIG. 9 depicts a variation in sterilizing power depending on a variation in operating time when Aspergillus niger was used as a bacterium sample, and FIG. 10 depicts a variation in sterilizing power depending on a variation in operating time when Escherichia coil was used as a bacterium sample;

FIGS. 11 and 12 illustrate a state in which, in accordance with a second embodiment of the present invention, the negative/positive ion generator is installed at the air outlet of the air purifier, in which FIG. 11 is a plan view, and FIG. 12 is a schematic sectional view;

FIG. 13 is a schematic sectional view illustrating a state in which, in accordance with a third embodiment of the present invention, the negative/positive ion generator is installed to operate at both the air inlet and air outlet of the air purifier;

FIG. 14 is a perspective view illustrating the negative/positive ion generator according to the third embodiment of the present invention;

FIG. 15 is a partial perspective view illustrating structures of holders for supporting protruded ends of the negative/positive ion generator according to the third embodiment of the present invention and a pair of fitting holes formed through a system case, to show mounting of the negative/positive ion generator to the air purifier;

FIGS. 16 and 17 are schematic sectional views illustrating assembly of the negative/positive ion generator to the system case using the holders in the case of FIG. 15, viewed from the inside of the system case, in which FIG. 16 shows a state before the assembly, and FIG. 17 shows a state after the assembly;

FIGS. 18 and 19 are schematic sectional views illustrating assembly of the negative/positive ion generator to the system case using the holders in the case of FIG. 15, viewed from the outside of the system case, in which FIG. 18 shows a state before the assembly, and FIG. 19 shows a state after the assembly;

FIG. 20 is a front view illustrating a state in which the negative/positive ion generator is mounted to a vehicle air conditioning system in accordance with a fourth embodiment of the present invention;

FIG. 21 is a partial perspective view illustrating structures of holders for supporting protruded ends of the negative/positive ion generator according to the fourth embodiment of the present invention and a pair of fitting holes formed through a system case, to show mounting of the negative/positive ion generator to the air conditioning system;

FIG. 22 is an enlarged sectional view corresponding to a portion A of FIG. 20;

FIG. 23 is a partial sectional view illustrating a state in which the negative/positive ion generator is mounted to the vehicle air conditioning system in accordance with a fifth embodiment of the present invention;

FIGS. 24 and 25 are partial sectional views illustrating a state in which the negative/positive ion generator is mounted to the vehicle air conditioning system in accordance with a sixth embodiment of the present invention;

FIG. 26 is a partial sectional view illustrating a state in which the negative/positive ion generator is mounted to the vehicle air conditioning system in accordance with a seventh embodiment of the present invention;

FIG. 27 is a partial sectional view illustrating an example in which the negative/positive ion generator is mounted to the vehicle air conditioning system in accordance with an eighth embodiment of the present invention; and

FIG. 28 is a perspective view illustrating another example in which the negative/positive ion generator is mounted to the vehicle air conditioning system in accordance with the eighth embodiment of the present invention.

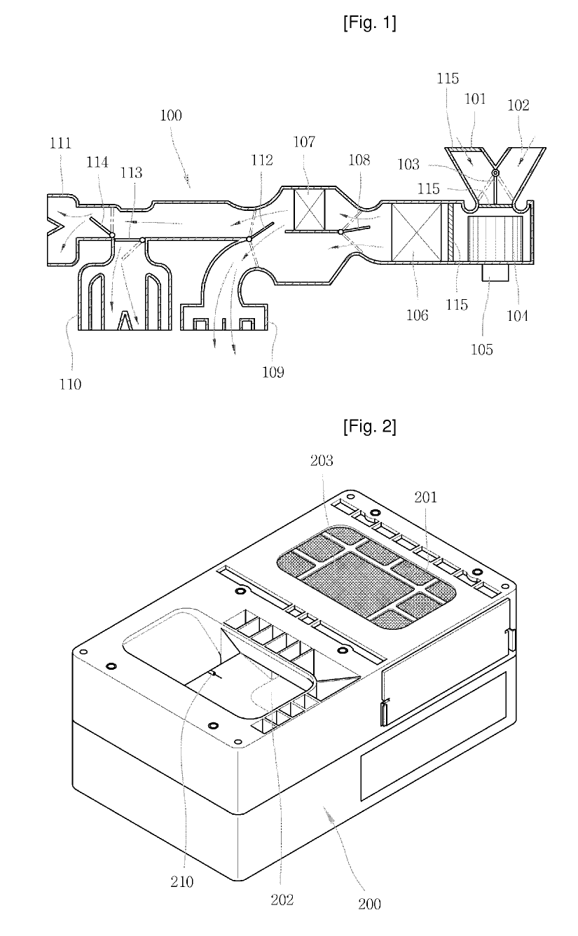

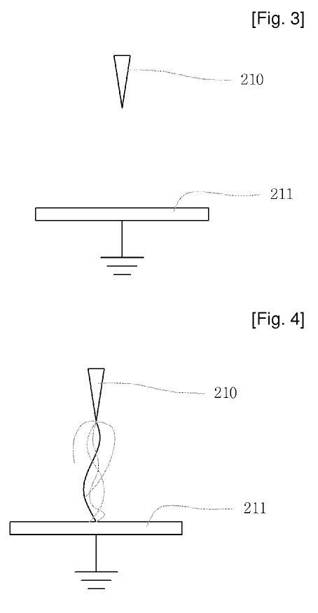

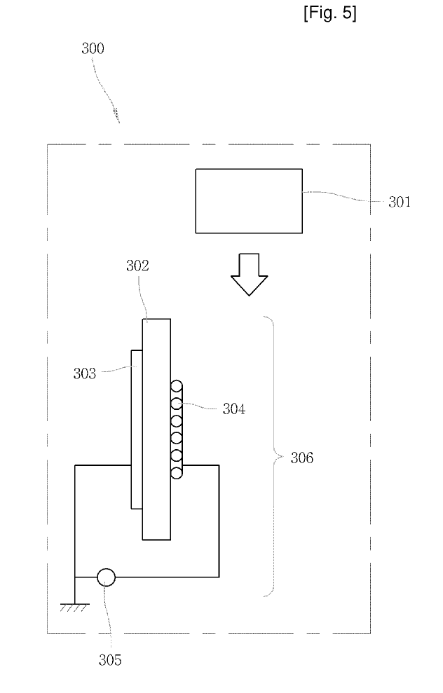

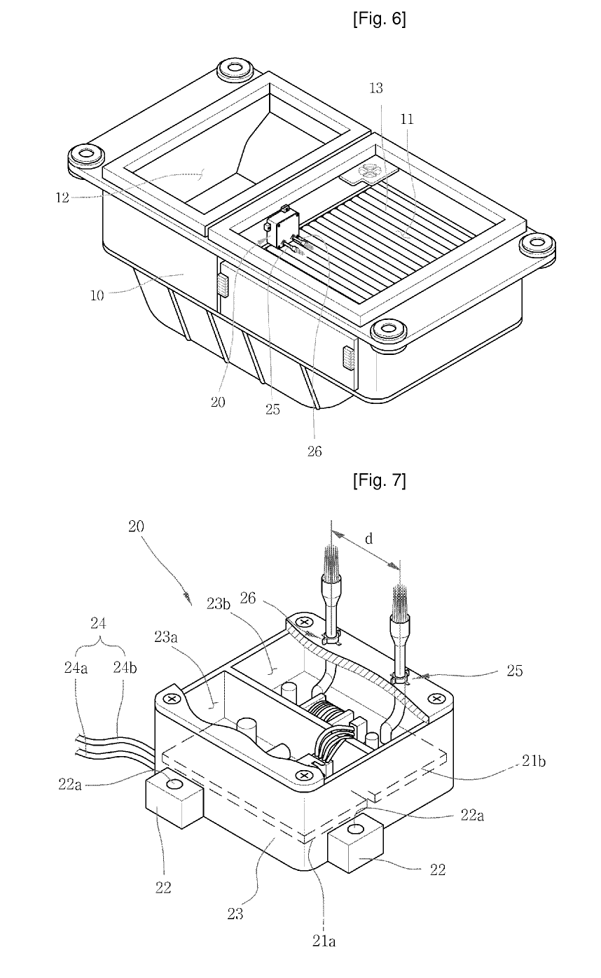

### BEST MODE FOR CARRYING OUT THE INVENTION

Hereinafter, preferred embodiments of the present invention will be described in detail with reference to the annexed drawings.

### First Embodiment

This embodiment is the case in which a negative/positive ion generator according to the present invention is applied to an air inlet of an air purifier for a vehicle.

As shown in FIGS. 6 to 8, the air purifier according to the present invention includes a case 10 provided with an air inlet 11 and an air outlet 12, and an air filter 13 arranged in the case 10 at the side of the air inlet 11, to absorb foreign matter containing in air introduced into the case 10 in accordance with driving of a blower fan 14 (FIG. 12), and thus to remove the foreign matter. The case 10 may be installed at an appropriate area in the cabin of the vehicle, for example, in the interior of an air conditioning system installed in the vehicle, on an instrument panel mounted to the front side of the cabin, or on a rack arranged in the rear of a rear seat in the cabin.

This embodiment has the feature that a negative/positive ion generator 20 is arranged in an air path at the side of the air inlet 11, to allow negative and positive ions to flow together with air introduced into the air inlet 11 in accordance with driving of the blower fan 14 such that the negative and positive ions are discharged into the cabin through the air outlet 12 and thus to sterilize and purify the cabin air to achieve a pleasant cabin environment.

The negative/positive ion generator 20 according to the present invention uses an electron emission system including a pair of discharge electrodes respectively having positive (+) and negative (−) polarities, to discharge electrons from the discharge electrodes while using the atmosphere as a dielectric, different from conventional corona discharge systems or conventional plasma discharge systems.

That is, in the negative/positive ion generator according to the present invention, a high-voltage pulse (having a high voltage level and small energy) is applied to the discharge electrodes, to directly emit electrons to the air without causing discharge noise. The emitted electrons are coupled with oxygen and moisture present in the air thereby generating a large amount of negative and positive ions without secondary pollutants, such as ozone and nitrogen oxides, harmful to the human body.

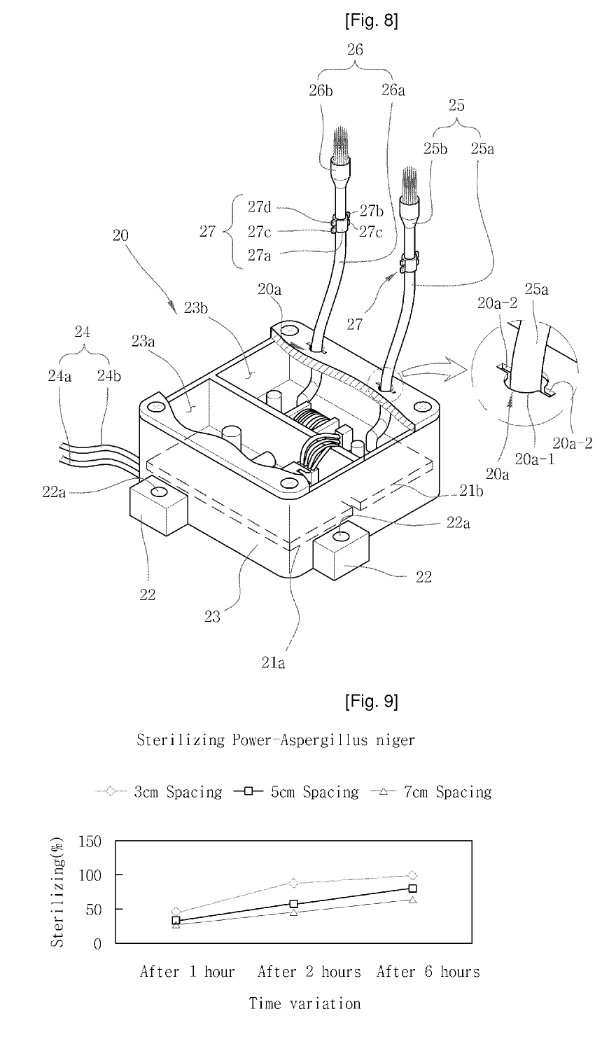

FIGS. 7 and 8 illustrate a structure of the negative/positive ion generator viewed from the bottom side. As shown in FIGS. 7 and 8, the negative/positive ion generator includes a body 23.

Fastening members 22 (only two are shown in the drawings) each having a fastening hole 22a are formed around the outer surface of a side wall of the body 23. Fastening screws (not shown) are threadedly fastened to the case 10 (FIG. 12) in a state in which they extend through the fastening holes 22a of the fastening members 22, respectively. Thus, the body 23 is firmly coupled to the case 10.

A first chamber 23a and a second chamber 23b are defined in the interior of the body 23. A constant-voltage generator 21a is installed in the first chamber 23a, whereas a high-voltage generator 21b is installed in the second chamber 23b.

The constant-voltage generator 21a is a main printed circuit board (PCB) on which transistors, diodes, condensers, resistors, etc. are mounted. The constant-voltage generator 21a maintains a voltage applied thereto via a power input unit 24 at a certain level, and protects an internal circuit of the negative/positive ion generator from electrical and physical impact applied to inner and outer portions of the body 23.

The power input unit 24 includes a negative (−) line 24a and a positive (+) line 24b, and functions electric power supplied from a battery of the vehicle to the constant-voltage generator 21a. The power input unit 24 is electrically connected to a control switch installed on the instrument panel in the cabin. Accordingly, it is possible to appropriately control generation of negative ions and positive ions by operating the control switch. The power input unit 24 may be connected to an ignition switch IGN, in order to continuously generate negative ions and positive ions once the vehicle starts.

The high-voltage generator 21b is a sub PCB on which a transformer, high-voltage diodes, condensers, etc. are mounted. The high-voltage generator 21b is electrically connected to the constant-voltage generator 21a, to amplify and boost the constant voltage applied from the constant-voltage generator 21a, and thus to generate a high-voltage pulse.

Again referring to FIGS. 7 and 8, the negative/positive ion generator includes a first discharge electrode 25 and a second discharge electrode 26 mounted to a certain wall portion of the body 23 while being spaced apart from each other.

As shown in FIG. 8, the first discharge electrode 25 includes a first high-voltage output line 25a connected to the high-voltage generator 21b, and a negative ion generator 25b provided at an end of the first high-voltage output line 25a. The negative ion generator 25b has a structure of metal fibers made of an alloy of various metal elements. The first discharge electrode 25, which has the above-described configuration, generates negative ions using a large amount of electrons discharged by the high-voltage pulse applied from the high-voltage generator 21b.

The second discharge electrode 26 includes a second high-voltage output line 26a connected to the high-voltage generator 21b while being spaced from the first high-voltage output line 25a by a certain distance d, and a positive ion generator 26b provided at an end of the second high-voltage output line 26a. The positive ion generator 26b has a structure of metal fibers made of an alloy of various metal elements. The second discharge electrode 26, which has the above-described configuration, generates positive ions using a large amount of electrons discharged by the high-voltage pulse applied from the high-voltage generator 21b.

Each of the negative ion generator 25b and positive ion generator 26b has a brush shape so that it has an increased discharge surface area. The negative ion generator 25b and positive ion generator 26b can appropriately control the amounts of negative and positive ions in accordance with the level of the voltage supplied from the high-voltage generator 21b, respectively.

Preferably, the spacing d between the first and second discharge electrodes 25 and 26 is within a range of 2 to 5 cm, taking into consideration electrical safety, sterilizing power (antibiosis), and amount of generated ions. When the spacing d is less than 2 cm, the brushes of the negative ion generator 25b and positive ion generator 26b may come into contact with each other during generation of ions from the negative ion generator 25b and positive ion generator 26b. In this case, there is a danger of a spark. On the other hand, when the spacing d is more than 5 cm, there is a problem in that degradation in sterilizing power occurs because ions generated from the negative ion generator 25b and positive ion generator 26b are spread widely. More preferably, the spacing d between the first and second discharge electrodes 25 and 26 is 3 cm.

In order to conduct a test for evaluating sterilizing power against bacterium samples depending on the spacing between the discharge electrodes, a certain amount of Aspergillus niger or Escherichia coil was sprayed as a bacterium sample into a test container of 500 mm×700 mm×500 mm, and air in the container was then collected every hour. The collected air was cultured, and was then treated by the negative/positive ion generator. Thereafter, the residual rate of the bacterium sample was measured. In this case, a voltage of 12V was applied to the negative/positive ion generator.

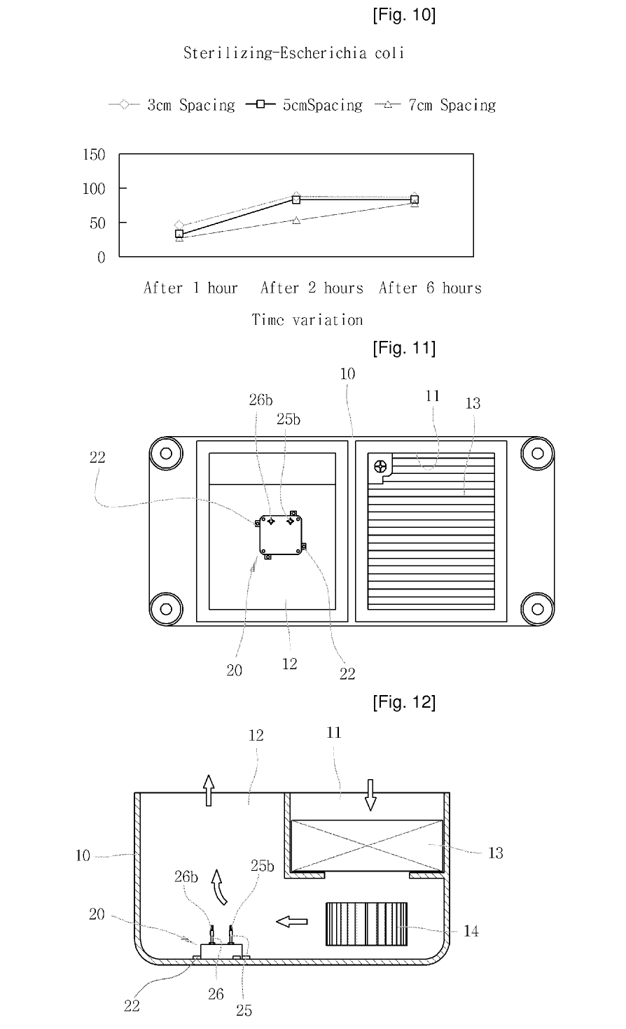

FIGS. 9 and 10 depict the results of the test.

FIG. 9 depicts a variation in sterilizing power depending on the operating time of the negative/positive ion generator when Aspergillus Niger was used as a bacterium sample. FIG. 10 depicts a variation in sterilizing power depending on the operating time of the negative/positive ion generator when Escherichia coil was used as a bacterium sample.

As can be seen from FIGS. 9 and 10, highest sterilizing power is obtained when the spacing d between the first discharge electrode 25 and the second discharge electrode 26 is 3 cm. This means that it is advantageous in terms of sterilization efficiency to reduce the spacing d between the first and second discharge electrodes 25 and 26 to be as small as possible.

Meanwhile, openings 20a are formed through the bottom wall of the body 23 beneath the high-voltage generator 21b to which the first and second high-voltage output lines 25a and 26a are connected. Each opening 20a includes a first opening 20a-1 having a circular shape, and a second opening 20a-2 extending horizontally from opposite sides of the first opening 20a-1. Locking members 27 are provided at certain portions of the first and second high-voltage output lines 25a and 26a, respectively. Each locking member 27 is releasably locked in an associated one of the openings 20a in a rotating manner. For this function, the locking member 27 includes a cylindrical body 27a having a shape corresponding to the shape of the first opening 20a-1, and upper and lower wings 27b and 27c horizontally protruded from opposite sides of the cylindrical body 27a at positions vertically spaced apart from each other.

The locking member 27 can be coupled to the opening 20a by aligning the wings 27b and 27c with the second openings 20a-2, inserting the locking member 27 into the interior of the body 23 such that only the lower wings 37b are received in the interior of the body 23, and rotating the locking member 27 by 90 such that the lower surfaces of the upper wings 27a are supported by the outer surface of the bottom wall of the body 23, as shown in FIG. 7. The locking member 27 can also be released from the opening 20a, as shown in FIG. 8, by reversely performing the above-described operations.

The reason why the locking members 27 having the above-described structure are used is that it may be necessary to adjust the extension lengths of the first and second high-voltage output lines 25a and 26a from the locking members 27. Where it is difficult to install the negative ion generator 25b and positive ion generator 26b in areas to be air-purified, due to insufficient extension lengths of the first and second high-voltage output lines from the locking members 27, the locking members 27 are released and the portions of the first and second high-voltage output lines 25a and 26a received in the interior of the body 23 are then drawn out to increase the extension lengths of the first and second high-voltage output lines from the locking members 27.

In accordance with the present invention, it is possible to simultaneously generate both the negative ions and the positive ions through the negative ion generator 25b and positive ion generator 26b installed at the areas to be air-purified, and to generate one of the positive and negative ions by controlling only the associated negative ion generator 25b or positive ion generator 26b.

Thus, the negative/positive ion generator 20 according to the present invention emit electrons to air from wide surfaces of the negative ion generator 25b and positive ion generator 26b in the first and second discharge electrodes 25 and 26 when electric energy is applied from the high-voltage generator 21b to the negative ion generator 25b and positive ion generator 26b. The emitted electrons are coupled with oxygen and moisture present in the air, thereby generating a large amount of negative ions. Accordingly, harmful substances present in the air, such as various bacteria, mold, and odor, can be reliably removed by the generated negative ions.

Hereinafter, the mechanism of the generation of negative and positive ions as described above will be described in more detail.

When high-voltage pulse current of strong negative electricity is applied from the high-voltage generator 21b to the negative ion generator 25b of the first discharge electrode 25, for emission of electrons to air, electrons are emitted together with heat energy. The electrons cause the molecular coupling of moisture (H₂O) in the air to be released. As a result, hydrogen and negative ions are generated, as expressed by the following Formula (1). At the same time, electrons are also emitted into the air from the positive ion generator 26b of the second discharge electrode 26 in accordance with application of high-voltage pulse current of strong positive electricity to the positive ion generator. The electrons emitted from the positive ion generator 26b cause the molecular coupling of moisture (H₂O) in the air to be released. As a result, oxygen and positive ions are generated, as expressed by the following Formula (2).

2H₂O+e⁻→4H+O₂⁻ (1)

2H₂O→4H⁺+O₂+e⁻ (2)

The negative ions (O₂⁻) and positive ions (H⁺) generated in the air are unstable, so that they are coupled with water molecules in the air, thereby forming ions having the form of clusters, namely, H₃O⁺ (H₂O) (n: arbitrary natural number) and O₂³¹ (H₂O) (m: arbitrary natural number).

These ions enclose harmful substances floating in the air, and chemically react with water molecules present therearound, thereby producing hydrogen peroxide (H₂O₂), hydrogen phosphate (HO₂), or hydroxyl radical (.OH), which is an activated species, as expressed by the following Formulas (3) and (4).

H₃O⁺(H₂O)+O₂³¹ (H₂O)ₘ→.OH+H₂O₂+(n+m)H₂O (3)

H₃O⁺(H₂O)+O₂⁻(H₂O)₃→HO₂+H₂O+(n+m)H₂O (4)

Since hydrogen peroxide (H₂O₂), hydrogen phosphate (HO₂), or hydroxyl radical (.OH) produced as described above is strongly reactive, it is changed into water molecules (H₂O) by taking hydrogen (H) from the cell wall of various harmful substances or odor present in the air. The cell walls of the harmful substances and odor, from which hydrogen (H) has been removed, are destroyed. As a result, the harmful substances and odor become inactive and harmless.

Thus, the negative/positive ion generator 20 according to the present invention can continuously discharge air beneficial to the human metabolism in addition to deodorizing and sterilizing the air because it generates a large amount of negative ions without producing secondary pollutants, such as ozone (O₃) and nitrogen oxides (NOₓ), harmful to the human body.

When the negative/positive ion generator 20 having the above-described function is installed at the air inlet 11 of the air purifier, which has a typical configuration, as shown in FIG. 6, it is possible to fundamentally purify the air initially introduced into the case 10 by the negative/positive ion generator 20, together with the filter 13 arranged at the side of the air inlet 11. Accordingly, there is an advantage in that it is possible to enhance air purification effects, and to extend the life span of the filter 13 when the negative/positive ion generator 20 is installed at the air inlet 11.

FIG. 6 illustrates the case in which the negative/positive ion generator 20 is installed at the side of the air inlet 11 upstream from the filter 13. In this case, it is preferred that the negative/positive ion generator 20 be mounted to a partition wall 15 for partitioning the air inlet 11 and air outlet 12 by a fastening means such as screws to the negative/positive ion generator 20 through the fastening members 22a, such that the negative ion generator 25b and positive ion generator 26b face the filter 13 at the upstream side of the filter 13.

Although the case in which the negative/positive ion generator 20 is installed at the upstream side of the filter 13 has been described, the present invention is not limited to this case. For example, the negative/positive ion generator 20 may be installed at the downstream side of the filter 13. In this case, negative and positive ions are emitted into the air purified through the filter 13, and are then uniformly diffused in the case 10 after removing pollutants and odor components attached to the filter 13 and sterilizing the air. Accordingly, it is possible to extend the life span of the filter 13, and to fundamentally prevent the phenomenon that odor components adsorbed on the surface of the filter 16 are re-discharged due to high-temperature air such as in the summer. Thus, it is possible to greatly enhance the air purification effect for the cabin.

Two negative/positive ion generators 20 may be installed at the upstream and downstream sides of the filter 13, respectively, to maximize the air purification effect in addition to further extend the life span of the filter 13.

A configuration in which only the negative/positive ion generator 20 is installed, and the filter 13 is dispensed with may also be implemented.

As apparent from the above description, when the negative ion generator 25b and positive ion generator 26b, which have a brush structure, are installed at the side of the air inlet 11, negative and positive ions respectively generated by the negative ion generator 25b and positive ion generator 26b, in particular, the negative ions, can remove harmful substances contained in the air, in particular, ambient air, introduced through the air inlet 11 into the case by the blower fan 14, and then attached to the surfaces of the case, namely by erosion causing elements such as SOx and NOx. The negative and positive ions can also remove odor discharged toward the filter 13.

### Second Embodiment

FIGS. 11 and 12 illustrate a state in which, in accordance with a second embodiment of the present invention, the negative/positive ion generator is installed at the air outlet of an air purifier identical to that of the first embodiment. FIG. 11 is a plan view, and FIG. 12 is a schematic sectional view.

Preferably, the negative/positive ion generator 20 is installed at the air outlet 12 by mounting the body 23 to an inner bottom surface of the case 10 via the fastening members 22 such that the negative ion generator 25b and positive ion generator 26b are upwardly directed to the air outlet 22.

Where the negative ion generator 25b and positive ion generator 26b are arranged at the air outlet 12, as described above, a large amount of negative and positive ions beneficial to the human body are directly discharged into the cabin by the negative ion generator 25b and positive ion generator 26b when air introduced into the air inlet 11 by the blower fan 14 is discharged into the cabin through the air outlet 12 after being primarily purified through the filter 13. Accordingly, it is possible to reliably remove various odor components present in the cabin, such as smoke and food odors, and to achieve sterilization. Thus, the air in the cabin can be more effectively purified.

### Third Embodiment

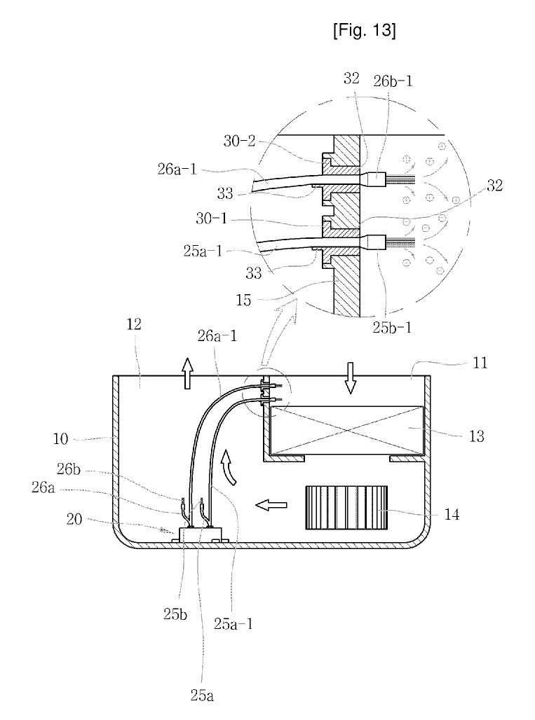

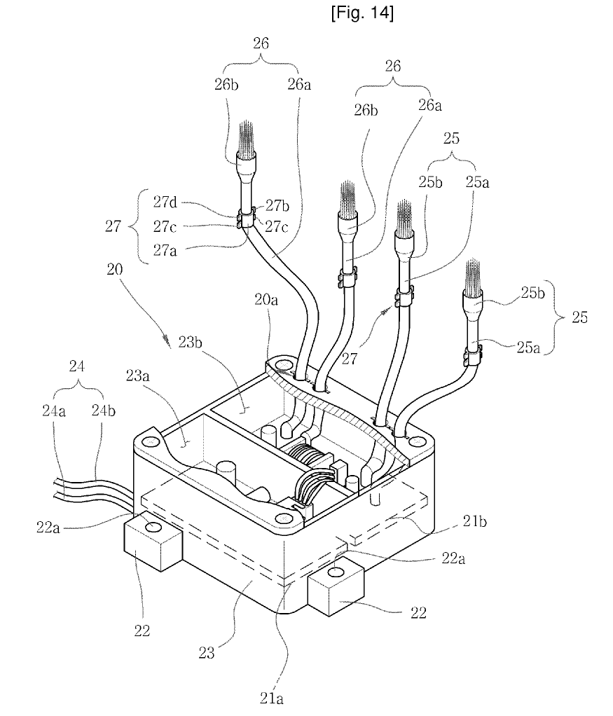

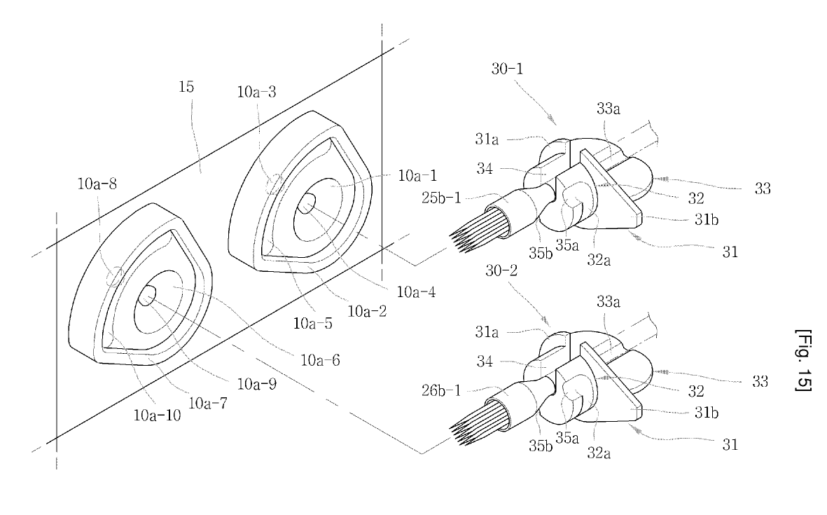

FIG. 13 is a schematic sectional view illustrating a state in which, in accordance with a third embodiment of the present invention, the negative/positive ion generator is installed to operate at both the air inlet and air outlet of an air purifier identical to that of the first embodiment. FIG. 14 is a perspective view illustrating the negative/positive ion generator according to the third embodiment of the present invention.

This embodiment has the feature that the first high-voltage output line 25a and second high-voltage output line 26a, connected to the negative/positive ion generator body 23, are branched into a plurality of first branched high-voltage output lines 25a, 25a-1, and second branched high-voltage output lines 26a, 26a-1, and a plurality of negative ion generators 25b, 25b-1 and a plurality of positive ion generators 26b, 26b-1 are formed at respective ends of the first branched high-voltage output lines 25a, 25a-1 and second branched high-voltage output lines 26a, 26a-1, and are positioned in pairs in different air paths.

In this case, it is preferable to install the negative/positive ion generator body 23 at the air outlet 12, as in the second embodiment, and the multiple pairs of the negative ion generators 25b, 25b-1 and positive ion generators 26b, 26b-1 are installed in the air paths such that one pair is arranged in the air path of the air outlet 12, whereas the other pair is arranged in the air path of the air inlet 11, as shown in FIG. 13.

The pairs of the first branched high-voltage output lines 25a, 25a-1 and second branched high-voltage output lines 26a, 26a-1 may be designed to have different lengths. In the case of FIG. 13, the pair of the first branched high-voltage output line 25a-1 and second branched high-voltage output line 26a-1 extending to the air inlet 11 are longer than the pair of the first branched high-voltage output line 25a and second branched high-voltage output line 26a extending to the air outlet 12.

As in the first embodiment, the negative ion generator 25b-1 and positive ion generators 26b-1 are mounted to the partition wall 15, which partitions the air inlet 11 and air outlet 12, through fitting holes 10a-1 and 10a-6 (FIG. 15) formed through the partition wall 15 while being laterally spaced apart from each other by a certain distance, by holders 30-1 and 30-2.

That is, as shown in FIG. 15, the negative ion generator 25b-1 and positive ion generators 26b-1 are fitted in the fitting holes 10a-1 and 10a-6 formed through the partition wall 15 while being laterally spaced apart from each other, using the holders 30-1 and 30-2 adapted to support the negative ion generator 25b-1 and positive ion generators 26b-1.

Hereinafter, the structure of the holders 30-1 and 30-2 will be described. Prior to this description, the structure of the case 10, to which the holders 30-1 and 30-2 are assembled, will be described.

A pair of cylindrical walls 10a-2 and 10a-7 is protruded from the partition wall 15 of the case 10 according to the present invention while being spaced apart from each other by a certain distance. The fitting holes 10a-1 and 10a-6 are centrally defined in the cylindrical walls 10a-2 and 10a-7 such that they extend through the partition wall 15. First and second stoppers 10a-3 and 10a-4 having a hemispherical shape are formed on an inner peripheral surface of the fitting hole 10a-1 at different positions, whereas first and second stoppers 10a-8 and 10a-9 having a hemispherical shape are formed on an inner peripheral surface of the fitting hole 10a-6 at different positions. The angle between the position of the first stopper 10a-3 or 10a-8 and the position of the second stopper 10a-4 or 10a-9 is about 90 to 180°, referably 150°.

Since the holders 30-1 and 30-2 have the same structure, the same constituent elements thereof will be designated by the same reference numerals.

The holder 30-1 or 30-2 includes a cover 31 having an outer diameter larger than the inner diameter of the fitting hole 10a-1 or 10a-6, to close the fitting hole 10a-1 or 10a-6, and a cylindrical protrusion 32 integrally coupled to one surface of the cover 31 such that it extends in perpendicular to the cover 31, and protruded by a length corresponding to the length of the fitting hole 10a or 10a-6. The cylindrical protrusion 32 has an outer diameter approximately equal to the inner diameter of the fitting hole 10a-1 or 10a-6. The holder 30-1 or 30-2 also includes a planar knob 33 integrally coupled to the other surface of the cover 31 and protruded from the cover 31, to allow the operator to grasp the holder 30-1 or 30-2 in an assembly process.

The protrusion 32 is formed with a U-shaped groove 34 extending in a radial direction, to receive and support the negative ion generator 25b-1. The U-shaped groove 34 further extends through a circular portion of the cover 31. A linear groove 33a is formed at one surface of the knob 33 such that it extends in the same direction as the U-shaped groove 34.

As shown in FIG. 15, the cover 31 is divided into two half portions with respect to the groove 34. One of the half cover portions, namely, a half cover portion 31b, has a hemispherical shape, whereas the other half cover portion 31b has substantially a triangular shape. The reason why the cover 31 has an asymmetrical structure as described above is that it is necessary to prevent erroneous assembly of the holders 30-1 and 30-2 to the fitting holes 10a-1 and 10a-6 due to carelessness by the operator. That is, the cover 31 is configured to have substantially a triangular half portion, namely, the half portion 31b, such that the half portion 31b functions as an assembly position determination guide for determining an accurate initial insertion position for the holder 30-1 or 30-2 into the fitting hole 10a-1 or 10a-6, and determining the assembly direction of the holder 30-1 or 30-2 in accordance with the determined initial insertion position.

For the above-described function of the cover 31, the wall 10a-2 or 10a-7 protruded from one wall of the case 10, and formed with the fitting hole 10a-1 or 10a-6 opened to the interior of the case 10 has a shape corresponding to the assembly position determination guide 31b, as shown in FIG. 15.

As can be seen from FIG. 15, the wall 10a-2 or 10a-7 is formed to have portions having different radiuses of curvature such that the portion having a larger radius of curvature is spaced from the center of the fitting hole 10a-1 or 10a-6 by a distance larger than that of the portion having a smaller radius of curvature, in order to enable the substantially-triangular assembly position determination guide 31b of the cover 31 closing the fitting hole 10a-1 or 10a-6 to rotate smoothly in an assembly direction without any interference in an assembly process for fitting the holder 30-1 or 30-2 into the fitting hole 10a-1 or 10a-6. A groove 10a-5 or 10a-10 to reduce weight is formed between the portion of the wall 10a-2 or 10a-7 having a larger radius of curvature and the fitting hole 10a-1 or 10a-6. The wall 10a-2 or 10a-7 has a structure inwardly recessed to a depth corresponding to the thickness of the cover 31 of the holder 30-1 or 30-2 so that it receives the cover 31.

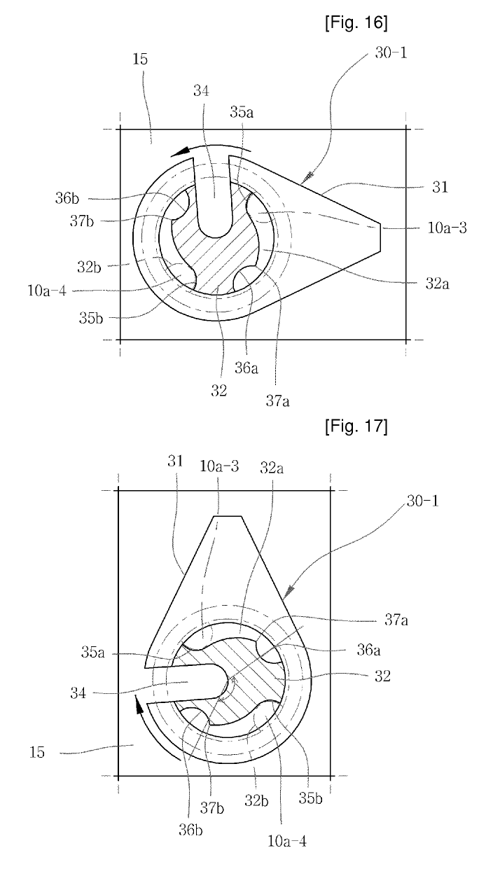

The protrusion 32 is provided with first and second guide grooves 32a and 32b (FIGS. 15 and 16) extending circumferentially at opposite sides of the radially extending U-shaped groove 34 while having asymmetrical structures. Although FIGS. 16 to 19 illustrate only the structure of the holder 30-1, for the convenience of illustration, the following description given with reference to FIGS. 16 to 19 is also equivalently applied to the other holder 30-2.

The first and second guide grooves 32a and 32b slide over the first and second stoppers 10a3 and 10a-4 formed at the fitting hole 10a-1, respectively, when the protrusion 32 rotates after being inserted into the fitting hole 10a-1 of the case 10. This will be described later. Of course, the first and second guide grooves 32a and 32b are not connected to each other at facing ends thereof, in order to prevent continuous rotation of the protrusion 32, as shown in FIGS. 16 and 17.

The first guide groove 32a functioning as described above has a first receiving groove 35a formed at a leading end of the first guide groove 32a arranged toward the U-shaped groove 34, to receive the first stopper 10a-3 formed at the fitting hole 10a-1 of the case 10. Similarly, the second guide groove 32b functioning as described above has a second receiving groove 35b formed at a leading end of the second guide groove 32b arranged away from the U-shaped groove 34, to receive the second stopper 10a-4 formed at the fitting hole 10a-1.

The first receiving groove 35a is formed at a position near the U-shaped groove 34, whereas the second receiving groove 35b is formed at a position far from the U-shaped groove 34. The angle between the positions of the first and second receiving grooves 35a and 35b is appropriately 90 to 180, and preferably 150, similar to the positions of the first and second stoppers 10a-3 and 10a-4.

The first and second receiving grooves 35a and 35b extend from the protruded or leading end of the protrusion 32 to respective leading ends of the first and second guide grooves 32a and 32b, and have a shape corresponding to that of the first and second stoppers 10a-3 and 10a-4, in order to receive the first and second stoppers 10a-3 and 10a-4 when the protrusion 32 is initially inserted into the fitting hole 10a-1 of the case 10.

First and second locking grooves 36a and 36b are formed at respective trailing ends of the first and second guide grooves 32a and 32b, in order to receive and lock the first and second hemispherical stoppers 10a-3 and 10a-4.

The first and second locking grooves 36a and 36b are arranged at opposite positions, similarly to the positions of the first and second receiving grooves 35a and 35b.

That is, as shown in FIG. 16, the second locking groove 36b and first receiving groove 35a are arranged at left and right positions near the U-shaped groove 34, respectively, whereas the second receiving groove 35b and first locking groove 36a are arranged at left and right positions far from the U-shaped groove 34, respectively. The first and second locking grooves 36a and 36b have a structure deeper than that of the first and second receiving grooves 35a and 35b.

The first guide groove 32a gradually reduces in width as it extends from the first receiving groove 35a formed at the leading end of the first guide groove 32a to the first locking groove 36a formed at the trailing end of the first guide groove 32a. Similarly, the second guide groove 32b gradually reduces in width as it extends from the second receiving groove 35b formed at the leading end of the second guide groove 32b to the second locking groove 36b formed at the trailing end of the second guide groove 32b.

Since the first and second locking grooves 36a and 36b deeper than the first and second receiving grooves 35a and 35b are formed at respective portions of the guide grooves 32a and 32b gradually reducing in width, first and second locking steps 37a and 37b are formed at portions of the guide grooves 35a and 35b to be respectively connected to the first and second locking grooves 36a and 36b.

Hereinafter, a method for assembling the holder 30-1 in accordance with the present invention will be described with reference to FIG. 15 and FIGS. 16 to 19.

FIGS. 16 to 19 illustrates an assembly procedure for the holder 30-1 in a state in which the negative ion generator 25b-1 is not held by the holder 30-1.

In order to fit the holder 30-1 into the fitting hole 10a-1 of the case 10, the holder 30-1 is first positioned such that the U-shaped groove 34 of the holder 30-1, which receives the negative ion generator 25b-1, is upwardly directed, as shown in FIGS. 15, 16 and 18. That is, the operator grasps the knob 33 of the holder 30-1, and inserts the holder 30-1 into the fitting hole 10a-1 in a state in which the assembly position determination guide 31b is directed toward the portion of the wall 10a-2 having a larger radius of curvature in the case 10.

After determining the initial insertion direction of the holder 30-1, the operator inserts the protrusion 32 into the fitting hole 10a-1 of the case 10.

In this state, the first and second stoppers 10a-3 and 10a-4, which are arranged at opposite positions in the fitting hole 10a-1, are naturally received in the first and second receiving grooves 35a and 35b formed at the protrusion 32. Thus, the initial assembly position of the holder 30-1 is determined. Accordingly, it is possible to prevent the holder 30-1 from being erroneously assembled due to carelessness by the operator.

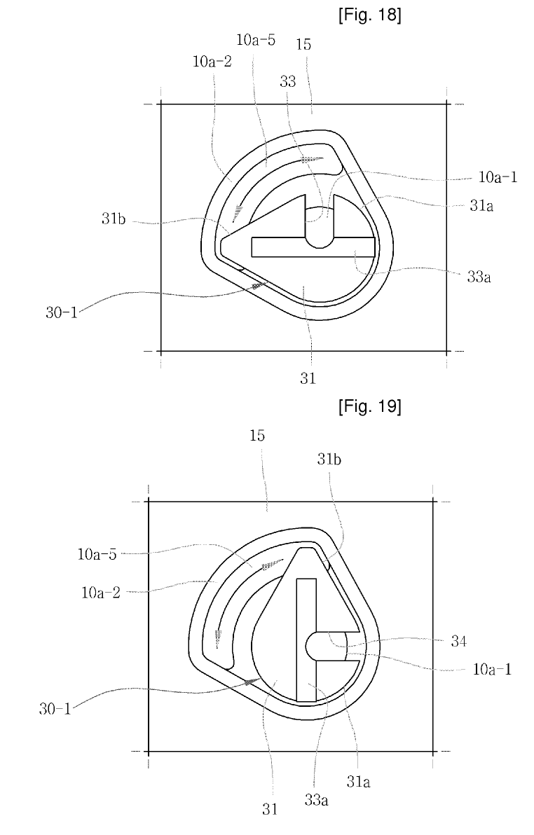

When the operator rotates the knob 33 in a direction indicated by an arrow (Although the arrow direction is shown as corresponding to the counterclockwise direction in FIGS. 16 and 17 because FIGS. 16 and 17 show the cross section of the holder 30-1, it actually corresponds to the clockwise direction in a state shown in FIGS. 18 and 19.), the assembly position determination guide 31b is rotated toward the groove 10a-5 to reduce weight. Accordingly, the first and second guide grooves 32a and 32b formed at the protrusion 32 rotate while sliding over the first and second stoppers 10a-3 and 10a-4, respectively.

When the rotation angle reaches about 90, the first and second locking grooves 36a and 36b formed at the first and second guide grooves 32a and 32b receive the first and second stoppers 10a-3 and 10a-4. In this state, the first and second stoppers 10a-3 and 10a-4 are locked by the locking steps 37a and 37b of the first and second locking grooves 36a and 36b. Accordingly, the holder 30-1 is completely assembled without being separated from the above position.

Although not shown, the assembly method for the holder 30-2 supporting the positive ion generator 26b-1 is identical to the assembly method for the holder 30-1.

FIGS. 18 and 19 illustrate the structure mounted to the partition wall 15 of the case 10 in accordance with the above-described assembly method, to hold the negative ion generator 25b-1 or positive ion generator 26b-1.

When one pair of the negative ion generators 25b, 25b-1 and positive ion generators 26b, 26b-1, extending from the high-voltage generator 21b mounted to the body 23 in a branched manner, are arranged protruding toward the air inlet 11 through the partition wall 15, and the other pair of the negative ion generators 25b, 25b-1 and positive ion generators 26b, 26b-1 are arranged protruding toward the air outlet 12, there is an advantage in that it is possible to purify contaminated air in the cabin in a short amount of time because the negative ion generators 25b, 25b-1 and positive ion generators 26b, 26b-1 can synthetically effect deodorization, sterilization, extend filter life span, and purify the air.

Also, since the negative ion generators 25b, 25b-1 and positive ion generators 26b, 26b-1 extending from the high-voltage generator 21b in a branched manner can be extended to desired places, they can be installed in any area where deodorization and sterilization are required. Accordingly, it is possible to efficiently sterilize and deodorize a wider area.

Meanwhile, when a plurality of negative ion generators 25b, 25b-1 and a plurality of positive ion generators 26b, 26b-1 are branched from the high-voltage generator 21b, the intensity of the high-voltage pulse applied to each negative or positive ion generator is reduced, thereby causing the amount of ions generated from each negative or positive ion generator to be reduced. However, the reduction in the amount of ions is not proportional to the number of branches. If the voltage applied to the high-voltage generator 21b is sufficiently high, it may be possible to increase the amount of ions generated from each positive/negative ion generator in proportion to the number of branches.

### Fourth Embodiment

This embodiment is the case in which the negative/positive ion generator according to the present invention is applied to a three-piece type air conditioning system including a blower unit, an evaporator, and a heater core respectively having independent configurations.

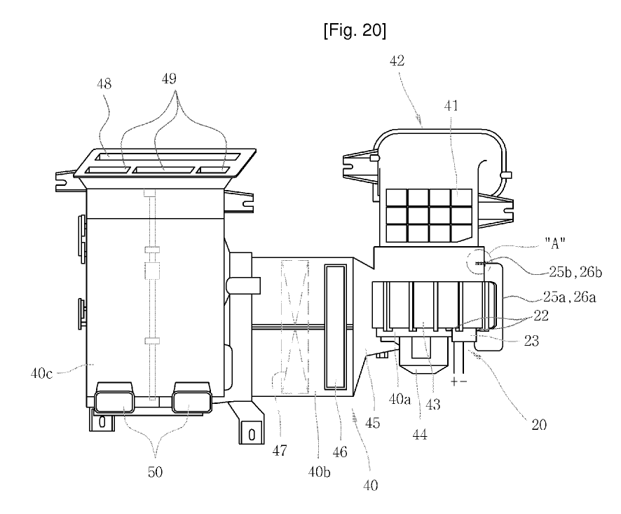

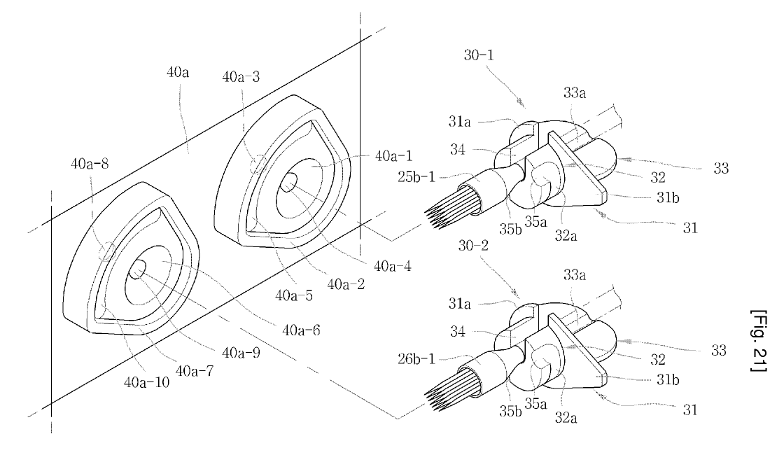

As shown in FIG. 20, the invention of the fourth embodiment includes a system case 40. The system case 40 includes a first case 40a including a blower unit 43, a second case 40b including an air filter 46 and an evaporator 47, and a third case 40c including a heater core (not shown).

The first case 40a includes an internal/external air switching door (not shown) for controlling the opening degrees of an internal air inlet 41 and an external air inlet 42 formed at the side of the air inlet. The blower unit 43, which is also included in the first case 40a, forces the internal/external air (hereinafter, simply referred to as “air”) to be introduced into the internal/external air inlets 41 and 42, and blows the air toward the evaporator 47, using an electric motor 44.

The second case 40b is connected to a blower duct 45 of the first case 40a. The evaporator 47, which is included in the second case 40b, functions to cool the air blown by the blower unit 43. The air filter 46, which is also included in the second case 40b, functions to absorb and remove foreign matter contained in the blown air.

The third case 40c is connected, at an inlet thereof, to an outlet of the second case 40b. The heater core (not shown), which is included in the third case 40c, functions to selectively exchange heat with the air received via the evaporator 47 in accordance with operation of a temperature control door (not shown). A plurality of vents 48, 49, and 50 are installed at an outlet of the third case 40c, to discharge air into different regions of the cabin.

The invention of the fourth embodiment has the feature that the negative/positive ion generator 20 (FIGS. 7 and 8) is installed in the air conditioning system having the above-described configuration, in order to sterilize and purify air present in the cabin by using negative and positive ions flowing together with air introduced into the system case when an air conditioner or a heat operates to cool or heat the cabin, and thus achieve a pleasant cabin environment.

The negative/positive ion generator 20 is electrically connected to a control switch, installed on an instrument panel in the cabin, to automatically control generation of negative and positive ions during a cooling or heating operation. Alternatively, the negative/positive ion generator 20 may be connected to an ignition switch IGN, in order to continuously generate negative and positive ions once the vehicle starts.

Where the negative/positive ion generator 20 is applied to an air conditioning system, as described above, it may be arranged at various areas in accordance with the object to be sterilized and purified.

For example, as shown in FIG. 20, the negative/positive ion generator 20 may be installed at the upstream side of the blower unit 43 in the first case 40a, to fundamentally purify air initially introduced into the first case 40a by the blower unit 43.

Preferably, the negative/positive ion generator 20 is mounted to the first case 40a in such a manner that the body 23 of the negative/positive ion generator 20 is firmly fastened to the outer bottom surface of the first case 40a by fastening means such as screws fastened through the fastening members 22, and only the negative ion generator 25b and positive ion generator 26b are received in the first case 40a.

That is, as shown in FIG. 21, the negative ion generator 25b and positive ion generator 26b are assembled as being fitted in first and second fitting holes 40a-1 and 40a-6 formed through the first case 40a at certain positions while being spaced apart from each other by a certain distance, using separate holders 30-1 and 30-2 respectively supporting the negative ion generator 25b and positive ion generator 26b.

The holders 30-1 and 30-2 have the same configuration as the holders 30-1 and 30-2 of the above-described third embodiment. Accordingly, the constituent elements of the holders 30-1 and 30-2 are designated by the same reference numerals as those of the third embodiment, and detailed description thereof will not be given.

The first case 40a, to which the holders 30-1 and 30-2 are assembled, has the same structure as that of the third embodiment. Accordingly, detailed description of the first case 40a will not be given.

The assembly method and order, and disassembly method and order of the holders 30-1 and 30-2 to the first case 40a are identical to those of the third embodiment, so detailed description thereof will not be given.

The assembly of the negative/positive ion generator 20 to the first case 40a using the holders 30-1 and 30-2 having the above-described configurations can be achieved by fitting the negative ion generator 25b and positive ion generator 26b of the negative/positive ion generator 20 through the holders 30-1 and 30-2, respectively, and then fitting the holders 30-1 and 30-2 into the first fitting hole 40a-1 and second fitting hole 40a-6 of the first case 40a.

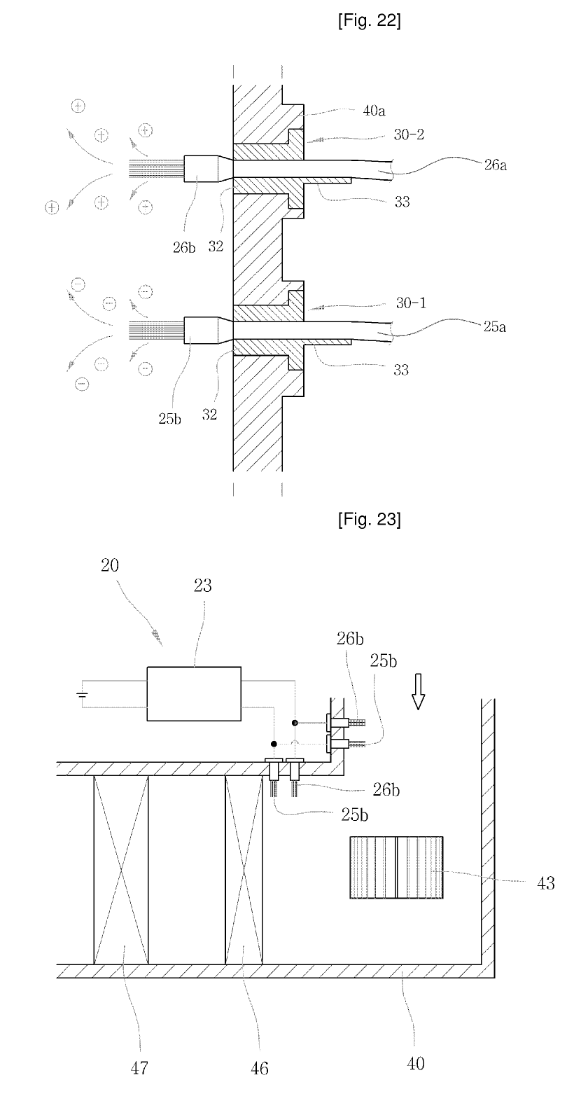

In the above-described assembled state, as shown in FIG. 22, the negative ion generator 25b and positive ion generator 26b of the negative/positive ion generator 20 are inwardly protruded from the inner surface of the first case 40a. Accordingly, negative ions and positive ions generated by the negative ion generator 25b and positive ion generator 26b are directly discharged into the interior of the first case 40a. As a result, it is possible to remove harmful substances contained in the air, in particular, ambient air, introduced into the first case 40a, and then attached to the surfaces of the first case 40a, namely, erosion causing elements such as SOx and NOx, by the negative ions. It is also possible to remove odor from the air before the air is discharged toward the air filter 46.

### Fifth Embodiment

FIG. 23 is a partial sectional view schematically illustrating a state in which the negative/positive ion generator 20 according to the present invention is installed at the upstream side of the air filter 46 in the system case 40 of the air conditioning system.

Similarly to the fourth embodiment, it is preferred in this embodiment that the negative/positive ion generator 20 be installed in such a manner that the body 23 of the negative/positive ion generator 20 is mounted to the outer surface of the system case 40 at a certain position, and only the negative ion generator 25b and positive ion generator 26b are arranged at the upstream side of the air filter 46 in a state of being fitted in the first and second fitting holes 40a-1 and 40a-6 (FIG. 21) formed through the system case 40, using the holders 30-1 and 30-2 (FIGS. 20 and 22).

Where the negative ion generator 25b and positive ion generator 26b are arranged at the upstream side of the air filter 46, a large amount of negative and positive ions generated by the negative ion generator 25b and positive ion generator 26b are directly emitted toward the surface of the air filter 46. After removing pollutants and odor components attached to the filter 13 and sterilizing the air, the negative and positive ions are uniformly diffused in the system case 40. Accordingly, it is possible to extend the life span of the filter 13. In particular, it is possible to fundamentally prevent the phenomenon that odor components adsorbed on the surface of the air filter 46 are re-discharged due to high-temperature air as in summer. Thus, it is possible to greatly enhance the air purification effect in the cabin.

### Sixth Embodiment

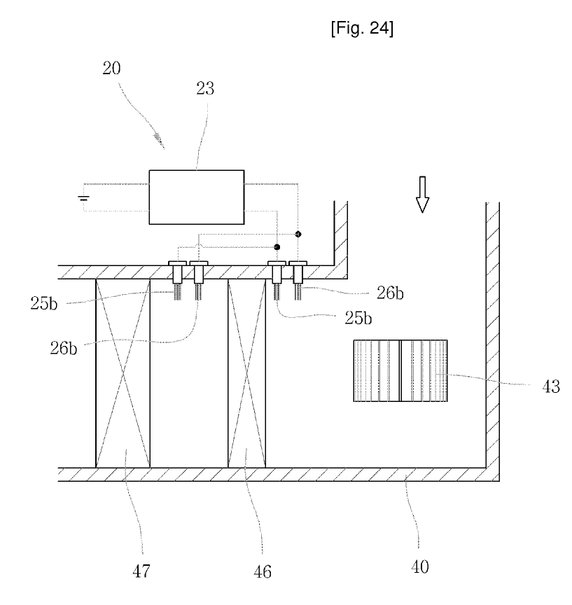

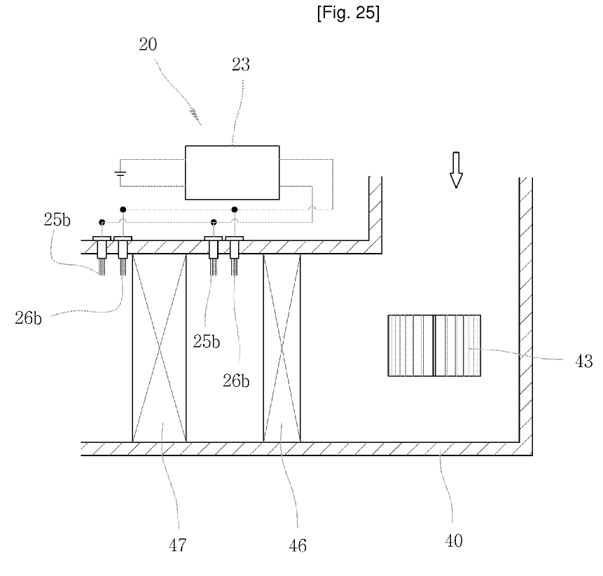

FIGS. 24 and 25 are partial sectional views schematically illustrating a state in which the negative/positive ion generator 20 according to the present invention is installed at the side of the evaporator 47 in the system case 40 of the air conditioning system. FIG. 24 illustrates a state in which the negative/positive ion generator 20 is installed at the upstream side of the evaporator 47. FIG. 25 illustrates a state in which the negative/positive ion generator 20 is installed at the downstream side of the evaporator 47.

Similarly to the fourth embodiment, it is preferred in this embodiment that the negative/positive ion generator 20 be installed in such a manner that the body 23 of the negative/positive ion generator 20 is mounted to the outer surface of the system case 40 at a certain position, and only the negative ion generator 25b and positive ion generator 26b are arranged at the upstream side of the evaporator 47 (FIG. 24) or at the downstream side of the evaporator 47 (FIG. 25) in a state of being fitted in the first and second fitting holes 40a-1 and 40a-6 (FIG. 21) formed through the system case 40, using the holders 30-1 and 30-2 (FIGS. 21 and 22).

Where the negative ion generator 25b and positive ion generator 26b are arranged at the upstream side of the evaporator 47, as shown in FIG. 24, it is possible to remove pollutants and odor components attached to the surface of the evaporator 47 and to perform sterilization, using a large amount of negative and positive ions generated by the negative ion generator 25b and positive ion generator 26b. In this case, it is possible to enhance the cooling efficiency of the evaporator 47, and to greatly enhance the air purification effect in the cabin.

Also, where the negative ion generator 25b and positive ion generator 26b are arranged at the downstream side of the evaporator 47, as shown in FIG. 25, a large amount of negative and positive ions beneficial to the human body are directly discharged into the cabin, together with air discharged into the cabin through the vents 48, 49, and 50 (FIG. 19) of the system case 40 after being primarily purified through the air filter 46. Accordingly, it is possible to reliably remove various odor components present in the cabin, such as smoke and food odors, and to sterilize the air. Thus, the air in the cabin can be more effectively purified.

### Seventh Embodiment

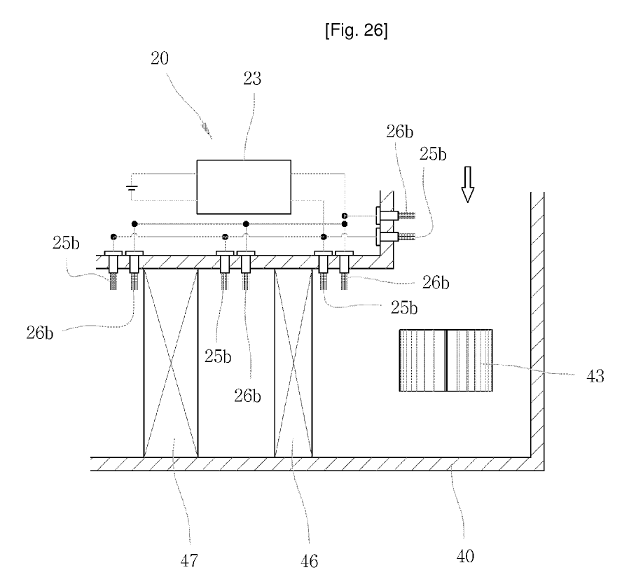

FIG. 26 is a partial sectional view schematically illustrating a state in which the negative/positive ion generator 20 according to the present invention is installed at various regions in the system case 40 of the air conditioning system.

This embodiment has the feature that each of the first high-voltage output line 25 and second high-voltage output line 26a connected to the single negative/positive ion generator body 23 are branched into a plurality of lines, and a plurality of negative ion generators 25b and a plurality of positive ion generators 26b are provided at the lines branched from the first high-voltage output line 25 and the lines branched from the second high-voltage output line 26, and are arranged at different air paths.

Similarly to the fourth embodiment, in this case, the negative/positive ion generator body 23 is mounted to the outer surface of the system case 40 at a certain position, and the plural negative ion generators 25b and plural positive ion generators 26b are mounted to the system case 40 such that they are arranged at the upstream side of the blower unit 43, between the blower unit 43 and the air filter 46, between the air filter 46 and the evaporator 47, and at the downstream side of the evaporator 47.

Where a plurality of negative ion generators 25b and a plurality of positive ion generators 26b are arranged in respective air paths defined in the system case 10, under the condition in which the single negative/positive ion generator body 23 is used, there is an advantage in that it is possible to purify contaminated air in the cabin in a short amount of time because the effects of deodorization, sterilization, and air purification can be synthetically exhibited, as in the fourth to sixth embodiment.

Although the fourth to seventh embodiments have been described in conjunction with the air conditioning system in which the air filter is arranged between the blower unit and the evaporator, the present invention is also applicable to an air conditioning system in which the air filter is arranged at the upstream side of the blower unit. In the latter case, the multiple brush-shaped negative and positive ion generators 25b and 26b branched from certain portions of the first and second high-voltage output lines 25a and 26b may be arranged in at least two of the air paths defined at the upstream side of the air filter, between the air filter and the blower unit, between the blower unit and the evaporator, and at the downstream side of the evaporator.

### Eighth Embodiment

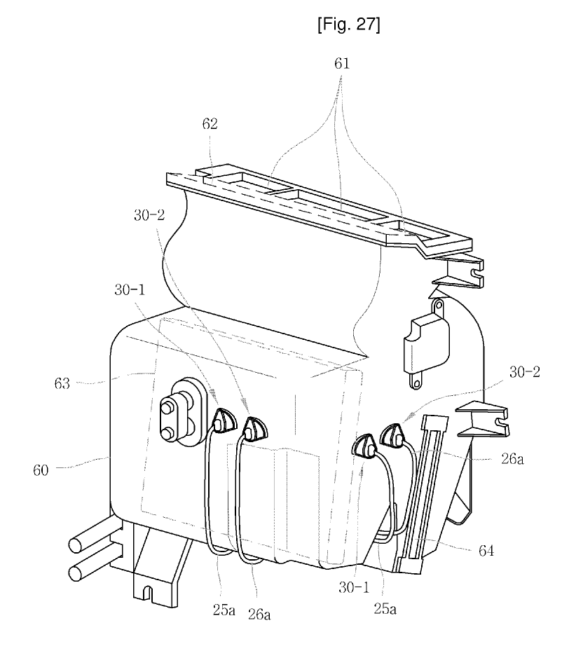

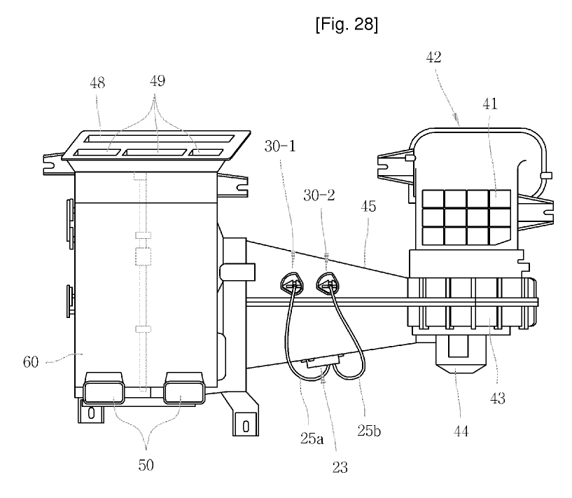

This embodiment is the case in which the negative/positive ion generator according to the present invention is applied to a semi-center mounting type air conditioning system including an evaporator and a heater core, which are integrally configured in a single system case. This embodiment has configurations and functions similar to those of the fourth to seventh embodiment, so repeated description thereof will not be given. FIGS. 27 and 28 illustrate the above-described semi-center mounting type air conditioning system.

FIG. 27 illustrates a system case 60 of the semi-center mounting type air conditioning system viewed from the rear side. The system case 60 includes a plurality of vents 61 and a plurality of vents 62 respectively provided at an air inlet and an air outlet connected to a blower duct 45 of a blower unit 43, as shown in FIG. 28. A heat exchanger is installed in the system case 60, to selectively exchange heat with air introduced into the system case 60 through the air inlet. In the drawings, 63 designates an evaporator installed in the system case 60, and 64 designates a fitting slot for a heater core installed in the system case 60 while being spaced apart from the evaporator 63 by a certain distance.

The negative/positive ion generator is mounted to the system case 60 having the above-described structure in such a manner that the body 23 of the negative/positive ion generator is mounted to the outer bottom surface of the system case 60, and only the negative ion generator 25b and positive ion generator 26b are received in the system case 60 in accordance with the method described in conjunction with the fourth embodiment.

In this embodiment, the negative ion generator 25b and positive ion generator 26b are mounted to the outer surface of a rear wall of the system case 60 by the holders 30-1 and 30-2 such that they extend through the rear wall of the system case 60.

That is, the negative ion generator 25b and positive ion generator 26b are mounted to the outer surface of the rear wall of the system case 60 such that they are arranged at the upstream or downstream side of the evaporator 63 arranged in the system case 60.

FIG. 27 illustrates the case in which the negative ion generator 25b and positive ion generator 26b are arranged at either the upstream or downstream side of the evaporator 63. FIG. 28 illustrates the case in which the negative ion generator 25b and positive ion generator 26b are arranged at the side of the blower duct 45.

In the case of FIG. 28, it is possible to conveniently and simply install the negative ion generator 25b and positive ion generator 26b without any restriction on the installation positions thereof, by virtue of the following reason, as compared to the case of FIG. 27.

Generally, air conditioning elements such as an evaporator, a heater core, and a temperature control door are installed in the system case 60. For this reason, when the negative ion generator 25b and positive ion generator 26b are installed in the system case 60, as shown in FIG. 27, it is necessary to arrange the ends of the negative ion generator 25b and positive ion generator 26b at positions having no interference with the air conditioning elements (namely, positions spaced apart from the air conditioning elements by about 20 mm or more). In particular, the case of FIG. 28 involves a restriction that the air conditioning elements should not be arranged in the flow path of the air introduced into the system case 60. On the other hand, in the case of FIG. 28, the negative ion generator 25b and positive ion generator 26b may be installed at any positions because there is no air conditioning element interfering with airflow in the blower duct 15.

In addition, in accordance with this embodiment, although not shown, it is possible to discharge, into the cabin, air completely purified by the negative/positive ion generator together with the air filter arranged at the upward side (upstream side) of the blower unit 43.

Where the negative ion generator 25b and positive ion generator 26b are installed as in the case of FIG. 27 or 28, it is possible to remove pollutants and odor components attached to the surface of the evaporator and to perform sterilization, using a large amount of negative and positive ions generated by the negative ion generator 25b and positive ion generator 26b. It is also possible to directly discharge a large amount of negative and positive ions beneficial to the human body into the cabin through the vents 61 and 62 of the system case 60. Thus, the air in the cabin can be more effectively purified.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention can be used in the fields associated with a vehicle air purifier with a negative/positive ion generator for maintaining a pleasant cabin environment, and a vehicle air conditioning system using the same.

1. An air purifier for a vehicle comprising:
a case including an air inlet and an air outlet;
a filter arranged in the case at the side of the air inlet;
a blower fan rotatably mounted in the case; and
a negative/positive ion generator arranged in an air path of at least one of the air inlet and the air outlet, to emit negative ions and positive ions to air in accordance with emission of electrons,
wherein the negative/positive ion generator comprises:
a body fixed to the case, the body including a high-voltage generator for generating high-voltage pulses; and
a first discharge electrode and a second discharge electrode electrically connected to the high-voltage generator, the first and second discharge electrodes generating electrons by the high-voltage pulses applied from the high-voltage generator, and emitting the electrons to the air path of the at least one of the air inlet and the air outlet, thereby causing negative ions and positive ions to be generated.

2. The vehicle air purifier according to claim 1, wherein the first discharge electrode and the second discharge electrode are spaced apart from each other by a spacing corresponding to 2 to 5 cm.

3. The vehicle air purifier according to claim 1, wherein each of the first discharge electrode and the second discharge electrode comprises a plurality of discharge electrodes branched from the high-voltage generator.

4. The vehicle air purifier according to claim 3, wherein the first and second discharge electrodes are arranged at the air path of the air inlet and the air path of the air outlet.

5. The vehicle air purifier according to claim 4, wherein the first and second discharge electrodes are arranged at an upstream or downstream side of a filter arranged in the air path of the air inlet.

6. The vehicle air purifier according to claim 1, wherein the first and second discharge electrodes are extendable from the body in a state of being fixedly locked to the body so that the first and second discharge electrodes can be arranged at an area spaced apart from the body.

7. The vehicle air purifier according to claim 6, wherein the first and second discharge electrodes are installed in the air path by holders respectively supporting the first and second discharge electrodes, and first and second fitting holes formed through the case in the air path, to fittably receive the holders, respectively.

8. The vehicle air purifier according to claim 7, wherein:
the first and second fitting holes are formed through central portions of cylindrical walls protruded from one surface of the case, respectively, and have inner peripheral surfaces each provided with first and second stoppers arranged at opposite positions, respectively; and
each of the holders comprises a cover for closing an associated one of the fitting holes, a protrusion integrally coupled to one surface of the cover, and fitted in the associated fitting hole, a receiving groove formed along the protrusion and the cover, to receive and support an associated one of the discharge electrodes, first and second guide grooves formed at the protrusion to extend circumferentially at opposite sides of the receiving groove while having asymmetrical structures, and first and second locking grooves respectively formed at the first and second guide grooves, to receive and lock the first and second stoppers when the protrusion rotates in an assembly direction.

9. The vehicle air purifier according to claim 1, wherein the negative/positive ion generator is electrically connected to an ignition switch of the vehicle, so that the negative/positive ion generator is turned on when the vehicle starts.

10. The vehicle air purifier according to claim 1, wherein the negative/positive ion generator is electrically connected to a control switch installed on an instrument panel arranged in a cabin of the vehicle so that the negative/positive ion generator is controlled in accordance with an operation of the control switch.

11. The vehicle air purifier according to claim 1, wherein each of the first and second discharge electrodes has a brush shape.

12. An air conditioning system for a vehicle comprising a system case defined with an air path, a blower unit for blowing air to the air path, an air filter for filtering the blown air, an evaporator for cooling the blown air, and a heater core for heating the blown air, further comprising:
a negative/positive ion generator comprising:
a body fixed to the system case, the body including a high-voltage generator for generating high-voltage pulses; and
a first discharge electrode and a second discharge electrode electrically connected to the high-voltage generator, the first and second discharge electrodes generating electrons by the high-voltage pulses applied from the high-voltage generator, and emitting the electrons to the air path of the system case, thereby causing negative ions and positive ions to be generated.

13. The vehicle air conditioning system according to claim 12, wherein the first discharge electrode and the second discharge electrode are spaced apart from each other by a spacing corresponding to 2 to 5 cm.

14. The vehicle air conditioning system according to claim 12, wherein each of the first discharge electrode and the second discharge electrode comprises a plurality of discharge electrodes branched from the high-voltage generator.

15. The vehicle air conditioning system according to claim 14, wherein the first and second discharge electrodes are arranged in at least two of an air path defined at an upstream side of the blower unit, an air path defined between the blower unit and the air filter, an air path defined between the air filter and the evaporator, and an air path defined at a downstream side of the evaporator.

16. The vehicle air conditioning system according to claim 15, wherein the air filter is arranged between the blower unit and the evaporator.

17. The vehicle air conditioning system according to claim 14, wherein the first and second discharge electrodes are arranged in at least two of an air path defined at an upstream side of the air filter, an air path defined between the air filter and the blower unit, an air path defined between the blower unit and the evaporator, and an air path defined at a downstream side of the evaporator.

18. The vehicle air conditioning system according to claim 17, wherein the air filter is arranged at an upstream side of the blower unit.

19. The vehicle air conditioning system according to claim 12, wherein the first and second discharge electrodes are arranged in a blower duct connecting the system case and the blower unit.

20. The vehicle air conditioning system according to claim 12, wherein the first and second discharge electrodes are extendable from the body in a state of being fixedly locked to the body so that the first and second discharge electrodes can be arranged at an area spaced apart from the body.

21. The vehicle air conditioning system according to claim 20, wherein the first and second discharge electrodes are installed in the air path by holders respectively supporting the first and second discharge electrodes, and first and second fitting holes formed through the system case in the air path, to fittably receive the holders, respectively.

22. The vehicle air conditioning system according to claim 21, wherein:
the first and second fitting holes are formed through central portions of cylindrical walls protruded from one surface of the system case, respectively, and have inner peripheral surfaces each provided with first and second stoppers arranged at opposite positions, respectively; and
each of the holders comprises a cover for closing an associated one of the fitting holes, a protrusion integrally coupled to one surface of the cover, and fitted in the associated fitting hole, a receiving groove formed along the protrusion and the cover, to receive and support an associated one of the discharge electrodes, first and second guide grooves formed at the protrusion to extend circumferentially at opposite sides of the receiving groove while having asymmetrical structures, and first and second locking grooves respectively formed at the first and second guide grooves, to receive and lock the first and second stoppers when the protrusion rotates in an assembly direction.

23. The vehicle air conditioning system according to claim 12, wherein the negative/positive ion generator is electrically connected to an ignition switch of the vehicle, so that the negative/positive ion generator is turned on when the vehicle starts.

24. The vehicle air conditioning system according to claim 12, wherein the negative/positive ion generator is electrically connected to a control switch installed on an instrument panel arranged in a cabin of the vehicle so that the negative/positive ion generator is controlled in accordance with an operation of the control switch.

25. The vehicle air purifier according to claim 12, wherein each of the first and second discharge electrodes has a brush shape.
